(19) United States
(12) Patent Application Publication
(10) Pub. No.: US 2015/0117583 A1
(43) Pub. Date: Apr. 30, 2015

(54) Nuclear Fusion Reactor with Power Extraction

(71) Applicant: Robert Alan Pitsch, Davenport, FL (US)

(72) Inventor: Robert Alan Pitsch, Davenport, FL (US)

(73) Assignee: Robert Alan Pitsch, Davenport, FL (US)

(21) Appl. No.: 14/068,232

(22) Filed: Oct. 31, 2013

(51) Int. Cl. G21B 1/11

(52) U.S. Cl. CPC G21B 1/11
USPC 376/100

(57) ABSTRACT

An apparatus for enhanced nuclear fusion reaction within a plasma by using voltage differential acceleration to raise its temperature and mechanically spinning the fusion containment utilizing centripetal force to concentrate ions density within a region by increasing the gravity in this region. Direct energy pickup from the fusion plasma, direct energy pickup to arc a chamber to produce a magnetic field for pick up with ferrite coil assemblies around the arc chamber to create electricity, collect the heat from the fusion containment to drive a turbine, heat engine or other heat suitable device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NANES OF THE PARTIES TO A JOINT RESEARCH AGREEMENT

Not Applicable

### INCORPORATION-BY-REFERENCE OF MATERIAL ON A COMPACT DISC

Not Applicable

### BACKGROUND OF THE INVENTION

(1) Field of Invention

The present invention relates to nuclear fusion reaction within a plasma by using voltage differential acceleration to raise its temperature and energy level. Recovering the energy from the fusion reaction in the form as electricity.

(2) Description of the Related Art

Excerpt from U.S. Pat. No. 4,826,646
All conventional magnetic approaches to the generation of fusion power are practically unable to take advantage of the natural large energy gain (G=ratio of energy output to energy input per fusion reaction) inherent in the fusion process. This “natural” gain can be as large a G=2000 for the fusion of deuterium (D or H.sub.2) and tritium (T or H.sub.3), the heavy isotopes of hydrogen (p or H.sub.1)
As an example of these effects, if ions are those of deuterium (D=H.sub.2) and the radius of the inner core is 0.1 that of the inner “surface” of the confinement field region, then the ratio of ion-generated pressure on the core to electron pressure on the (external) confining field will be roughly 6100:1. The physics phenomena invoked in this invention thus have the effect of creating an electrical “gas” inside the magnetic field region whose (dynamic) pressure at large radii is very much less than its pressure at small radii within the volume which it occupies.
Fusion reaction products will generally escape regions containing the plasma, electrostatic fields, and electrons, and be deposited in and on structures around but outside of these regions. Since these products are all positively charged and carry high energy (several Mev each) their energy may be converted directly to electrical energy in external circuits by causing the external structures (on which the fusion products impinge) to operate a high positive electrical potentials (voltages). With such an arrangement the positively-charged fusion products must escape “up hill” against the applied positive potentials, and can drive electrical energy into any circuit to which the external structures are connected and which closes back to the plasma/electron/well region.
In summary, previous work in inertial, magnetic, and electrostatic confinement aimed at the confinement of charged particles (ions), for the purpose of creating conditions useful for the generation of nuclear fusion reactions between them, has shown that:
(1) Magnetic fields do not provide restoring forces to charged particles in motion, or to confine plasma particles; they provide deflecting forces, at right angles to the direction of motion of the particles. Electrostatic, electrodynamics, and other electric fields can provide direct restoring forces for the confinement of charged particles.
(2) Even the most favorable magnetic confinement geometries lose charged particles by gyro guiding center shifting due to microscopic collisions between particles. Such collisions are essential for the creation of nuclear reactions.
(3) Collisions between particles of like sign have the most effect on ion losses. Such collisional losses are governed by the gyro radii of ion/ion collisions in conventional magnetic confinement schemes. Electron gyro radii are very much less than those of ions of comparable energy.
(4) Electron and ion motions in magnetic fields are of opposite sign. This results in the electric polarization of the plasma, with the establishment of an ambipolar dielectric field. Plasma losses are then set by the rate of ion/ion transport collisions across the field.
(5) Inertial-electrostatic potential wells established and maintained by charged particle injection alone and held solely within electric field structures are stable only for confinement at particle densities below a certain critical value. This is found to be too low for the production of nuclear fusion reaction rates useful for power generation.

Excerpt from U.S. Pat. No. 5,160,695
Conventional magnetic confinement approaches to fusion power generation are practically unable to take advantage of the large energy gains (G=ration of energy output to energy input per fusion reaction) naturally found in the fusion reactions between various reactive isotopes of the light elements. These gains can be large as G.apprxeq.1000-2000 for the fusion of deuterium (D or ,sup.2 H), with tritium (T or .sup.3 H), the two heavy isotopes of hydrogen (p or .sup.1H), according to D+T.fwdarw.sup.4 He+.sup.o.n (+17.6 MeV), or up to G.apprxeq.50-100 for fusion between hydrogen (p) and boron-11 (.sup. 11 B), p+.sup.11 B.fwdarw.3 .sup.4 He(+8.6 MeV). In spite of this, it is found that the large power requirements for confinement and plasma heating in magnetic confinement approaches place practical engineering limits on the energy gain potentially achievable to 2<G<5. Most of the world's fusion research efforts have been devoted to the magnetic confinement approach, in which strong magnetic fields are used to constrain the motion of fusion fuel ions (and electrons) along closed field lines in toroidal field geometries, for example, or along open field lines with large internal magnetic reflection characteristics, as in double-ended “cusp” mirror or solenoidal magnetic “bottle” confinement schemes. These magnetic approaches thus suffer from the use of an indirect and therefore inefficient means of constraining ion loss motion towards the confining walls of the system.

Excerpt from U.S. Pat No. 4,837,772
An electrically self-oscillation radio frequency-excited gas laser. The discharge section of the laser resonates at a desired radio frequency as a result of incorporation the discharge section into the feedback loop of a power oscillator circuit. This laser structure facilitates initial plasma breakdown and adapts its frequency depending upon whether the gas in the discharge section has broken down. When the laser plasma tube is integrated with the oscillator, the laser is also somewhat smaller compared to gas laser having conventional crystal-controlled amplifier chains.

This invention overcomes previous attempts to increase the ion density by magnetic and Inertial-electrostatic potential confinement methods. By using centripetal force, gravity, the ion density is increased so enhanced fusion can occur at a rate economical for its extraction. The gravity difference between the voltage electrode structure and ground electrode structure is great enough to allow for electron/ion acceleration assist needed for fusion. Electrostatic acceleration is necessary to start the fusion process.

### SUMMARY OF THE INVENTION

An apparatus of enhanced nuclear fusion reaction with power extraction, which overcomes previous attempts to increase the ion density by magnetic and Inertial-electrostatic potential confinement methods. By using centripetal force, gravity, the ion density is increased so enhanced fusion can occur at a rate economical for its extraction. The gravity difference between the voltage electrode structure and ground electrode structure is great enough to allow for electron/ion acceleration assist needed for fusion. Electrostatic acceleration is necessary to start the fusion process.

The containment of the fusion plasma is a capsule, wedge or other suitable design made with Pyrex®, ceramic or other suitable material with three electrodes, voltage electrode, ground electrode and power out electrode or four electrodes, voltage electrode, ground electrode, power out electrode, and RF in electrode. The RF in electrode is used for higher power output.

The voltage electrode with a structure positioned proximate at the end of said electrode. The ground electrode with a structure positioned proximate at the end of said electrode. The power out electrode with a structure positioned proximate at the end of said electrode called a target. The RF in electrode with a structure positioned proximate at the end. The voltage electrode and ground electrode for being an insertion of power for accomplishing the fusion reaction. The structures can be open such as a screen or a closed structure. The screen would be used for the voltage electrode structure and closed structure for ground electrode and RF in electrode. The closed structures can be flat or curved.

The electrodes are insulated in the containment are insulated to prevent arcing outside the fusion reaction area.

The containment is in a low-pressure state and can withstand the heat generated by fusion reaction.

The fusion containment and holder is mechanically spun in a circle by a motor. There is a tradeoff between motor revolutions per minute and radius of the holder for the same centripetal force gravity.

The maximum gravity is on the target, placed behind the plasma, lesser gravity on the voltage electrode structure and least gravity on the ground electrode structure. If the RF in electrode structure is used it would be positioned at a lower gravity respect to the ground electrode structure. The gravity difference between the voltage electrode structure and ground electrode structure is great enough to allow for electron/ion acceleration assist needed for fusion.

As the motor revolutions per minute are increased, the gravity in the containment is also increased. The centripetal force gravity pull on the voltage electrode structure, ground electrode structure, and target which is connected to the power output electrode are different due to the positioning in the containment

The target made of graphite, beryllium or other suitable material. The target is mounted on a heat spreading dissipating conductor. The target and heat spreading dissipating conductor is supported above the containment with insulators. The conductor is facing the containment bottom. At the highest gravity level, the target receives the products from the fusion reaction from the voltage electrode structure.

The voltage electrode structure positioned proximate to the end of the electrode is held above the target with insulators.

The containment can take on various configurations to allow the gravity at the outside to be greater than the inside such as a rotating wedge or multiple rotating wedges or rotating capsule or multiple rotating capsules. The rotating wedges reduce the air turbulence created by the spinning fusion containments.

The fusion material can be deuterium, deuterium and tritium, hydrogen and boron-11 or other elements that can cause fusion. Tritium can be bread from a deuterium reaction with the use of lithium.

The plasma is excited with differential high voltage energy, pulsing differential high voltage energy to accelerate the ions between the voltage electrode structure and ground electrode structure. A separate arc gap may be needed in series with the voltage electrode to increase the ionization voltage.

With addition of the RF in electrode and structure in the containment placed at the lower gravity position respect to the ground electrode structure, the plasma is excited with a RF source to ionize the plasma in the vicinity of the ground electrode structure. The differential high voltage energy or pulsing differential high voltage energy between the voltage electrode structure and ground electrode structure is used to accelerate the ions and raise their temperature. A separate arc gap may be needed in series with the voltage electrode to increase the ionization voltage

The direct energy pickup from the target through the power out electrode would be at a MeV level requiring significant insulation to prevent arcing. A high voltage transformer converter can be connected to it.

The direct energy picked up by the target through the power out electrode can be used to arc a chamber. The arcing chamber limits the energy build up on the target. A capacitor stores the target energy unit the chamber arcs and dumps the energy in the arc. The arcing chamber produces a magnetic field for pick up with ferrite coil assemblies to create electricity.

The heat produced by the fusion reaction is captured by a heat chamber around the fusion containments and can be used to power turbines, heat engine, or other heat suitable device.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates a fusion containment having an embodiment of 3 electrodes, structures and target.

FIG. 2 shows a top view of the fusion containments of FIG. 1.

FIG. 3 illustrates a wedge fusion containment having an embodiment of 3 electrodes, structures and target.

FIG. 4 shows the top view of two wedge fusion containments of FIG. 3.

FIG. 5 illustrates the two fusion containments in their holders on the motor shaft for rotation with slip rings and brushes for connections to the voltage electrode, ground electrode, and power out electrodes. The power out electrode and brushes are connected to arc chambers having ferrite coil assemblies mounted around them. A capacitor connected to the power out electrode brushes and ground.

FIG. 6 shows a top view of two mounted fusion containments in their holders of FIG. 5.

FIG. 7 illustrates the two fusion containments in their holders on the motor shaft for rotation with slip rings and brushes for connections to the voltage electrodes and ground electrodes. The power out electrode brushes are connected to transformers.

FIG. 8 shows a top view of two mounted fusion containments in their holders of FIG. 7.

FIG. 9 illustrates the two fusion containments in their holders on the motor shaft for rotation with slip rings and brushes for connection to the voltage electrodes and ground electrodes. It also illustrates the heat containment around the fusion containments and holder. The power out brushes are connected to arc chambers having ferrite coil assemblies mounted around them. A capacitor connected to the power out electrode brushes and ground.

FIG. 10 shows a top view of two mounted fusion containment with the heat containment around the fusion containments of FIG. 9.

FIG. 11 illustrates a fusion containment having an embodiment of 4 electrodes, structures and target.

FIG. 12 shows a top view of the fusion containments of FIG. 11.

FIG. 13 illustrates a wedge fusion containment having an embodiment of 4 electrodes, structures and target.

FIG. 14 shows the top view of two wedge fusion containments of FIG. 13 and RF power boards for RF in electrodes.

FIG. 15 illustrates the two fusion containments in their holders on the motor shaft for rotation with slip rings and brushes for connections to the voltage electrode, ground electrode, RF in electrode, and power out electrodes. The power out electrode brushes are connected to arc chambers having ferrite coil assemblies mounted around them. A capacitor connected to the power out electrode brushes and ground.

FIG. 16 shows a top view of two mounted fusion containments in their holders of FIG. 15 and RF power boards for RF in electrodes.

FIG. 17 illustrates the two fusion containments in their holders on the motor shaft for rotation with slip rings and brushes for connections to the voltage electrodes, ground electrodes, and RF in electrodes. The power out electrode brushes are connected to transformers.

FIG. 18 shows a top view of two mounted fusion containment assemblies in their holders of FIG. 17 and RF power boards for RF in electrodes.

FIG. 19 illustrates the two fusion containments in their holders on the motor shaft for rotation with slip rings and brushes for connection to the voltage electrodes and ground electrodes. It also illustrates the heat chamber around the fusion containments. The power out electrode brushes are connected to arc chambers having ferrite coil assemblies mounted around them. A capacitor connected to the power out electrode brushes and ground.

FIG. 20 shows a top view of the mounted fusion containment with the heat containment around the fusion containments of FIG. 19 and RF power boards for the RF in electrodes.

FIG. 21 shows the ferrite coil assembly with gap.

FIG. 22 shows the power transformer assembly.

FIG. 23 shows the power output with target for the containment, target is mounted on a heat spreading dissipating conductor and standoffs.

FIG. 24 shows the power output with target for the wedge containment, target is mounted on a heat spreading dissipating conductor and standoffs.

Corresponding reference characters indicate corresponding parts throughout the several views. The exemplifications set out herein illustrate one embodiment of the invention, in one form, and such exemplification is not to be construed as limiting the scope of the invention in any manner.

### DETAILED DESCRIPTION OF THE INVENTION

An apparatus of enhanced nuclear fusion reaction with power extraction, which overcomes previous attempts to increase the ion density by magnetic and Inertial-electrostatic potential confinement methods. By using centripetal force, gravity, the ion density is increased so enhanced fusion can occur at a rate economical for its extraction. The gravity difference between the voltage electrode structure and ground electrode structure is great enough to allow for electron/ion acceleration assist needed for fusion. Electrostatic acceleration is necessary to start the fusion process.

The Sun at its center, hydrogen weighs 160 times that of water. Water is approximately 18 atomic mass units*160=2880 times its weight, which is the Sun's core gravity. This fact identifies the use of gravity as a concentrator of the molecules used in its fusion reaction. The high gravitational force reduces the molecular motion of the ions. This figure is for hydrogen fusion. When deuterium or deuterium and tritium are used, these molecules are heavier thus can combine easier at this gravitational level. The Sun has burned off the deuterium and tritium elements.

To create the Sun's core gravity with mechanical spinning centripetal force for about 2880g:1:

The voltage electrode centripetal force gravity=[radius in meters*[[[PI*RPM]/30 ]̂2]]/9.81(gravity)2897 g=[0.2*[[[3.14159*3600]/30]̂2]]/9.81 There is a tradeoff between revolutions per minute and radius of the arm for the same centripetal force gravity.

We start with Newton's Law (of gravitation) and Coulomb's Law. We can suppose that a mass and a charge will create respectively a gravitational field and an electrostatic field, which act through space. The mass and charge are the sources of fields and the resultant field at a point in space is the vector sum of the fields due to the individual sources. Thus, if a mass m is placed in a gravitational field of intensity g it experiences a force Fg=mg and a charge q is placed in a electrostatic field of intensity E it experiences a force Fe=qE.

A voltage differential is used to raise the plasma temperature. Raising the temperature of a molecule causes the mean free path between molecules to increase. The formula for a perfect gas is PV=NRT, Pressure, Volume, Number of moles, R universal gas constant, Temperature. The formula shows the relationship between volume and temperature if pressure is constant. The increased mean path reduces the overall probability of collisions. This increase in the mean free path can be reduced by mechanically spinning the fusion containment utilizing centripetal force to concentrate ions density within a region by increasing the gravity in this region. The increase in gravity reduces the mean free path between molecules, allows greater concentration of ion density, and increases the probability of collisions. The gravity force on the molecules at the voltage electrode at an arm radius of 0.2 meters and 3600 revolutions per minute rotational speed is 2897 g. Using the formula PV=NRT, T=15,7000,000 deg K but the V spacing is increased from 273 deg. K to 15,700,000 deg K/2899 g=5000 deg. K by the use of gravity. The deg K can also be expressed as electron/ion voltage. With the formula 1 eV/Kb=1.60217653E-19 J/1.3806505E-23 J/K=11604.5 deg K=1eV. The Boltzmann constant is 1.3806505E-23 J/K. For a temperature of 15,700,000 deg K the electron/ion voltage would be 1352.9 eV. Gravity and electrostatic acceleration are mathematically similar. The gravity differential acceleration from the ground electrode structure to the voltage electrode structure is 1378 g. The electron/ion voltage needs to be increased 1352.9−1378=−25.1. Since the number is negative only electrostatic acceleration is needed for the 15,700,000 deg K temperature.

Example of electrode structure placement and centripetal g force associated with that placement referenced to the center of the motor shaft:

Centripetal force gravity=[radius in meters*[[[PI*RPM]/30]̂2]]/9.81(gravity)

The power electrode, target:

Centripetal force gravity=3267 g=[0.2255*[[[3.14159*3600]/30]̂2]]/9.81

The voltage electrode structure placed 1 inch from target:

Centripetal force gravity=2897 g=[0.2*[[[3.14159*3600]/30]̂2]]9.81

Ground electrode structure placed 4.75 inches from target:

Centripetal force gravity=1519 g=[0.1049*[[[3.14159*3600]/30]̂2]]/9.81

RF in electrode structure (if used) is placed 5.50 inches from target:

Centripetal force gravity=1243 g=[0.0858*[[[3.14159*3600]/30]̂2]]/9.81

Gravity acceleration from the ground electrode structure to the voltage electrode structure is 2897 g−1519 g=1378 g.

Gravity acceleration from the voltage electrode structure to the power takeoff, target is 3267 g−2897 g=370 g.

It is shown in U.S. Pat. No. 4,826,646 the plasma-confining field needs to be roughly 6100:1.

Example of electrode structure placement and centripetal g force associated with that placement referenced to the center of the motor shaft:

Centripetal force gravity=[radius in meters*[[[PI*RPM]/30 ]̂2]]/9.81(gravity)

The power electrode, target:

Centripetal force gravity=6868 g=[0.2255*[[[3.14159*5220]/30]̂2]]/9.81

The voltage electrode structure placed 1 inch from target:

Centripetal force gravity=6091 g=[0.2*[[[3.14159*5220]/30]̂2]]/9.81

Ground electrode structure placed 4.75 inches from target:

Centripetal force gravity=3195 g=[0.1049*[[[3.14159*5220]/30]̂2]]/9.81

RF in electrode structure (if used) is placed 5.50 inches from target:

Centripetal force gravity=2613 g=[0.0858*[[[3.14159*5220]/30] ̂2]]/9.81

Gravity acceleration from the ground electrode structure to the voltage electrode structure is 6091 g−3195 g=2896 g.

Gravity acceleration from the voltage electrode structure to the power takeoff, target is 6868 g−6091 g=777 g.

Magnetic control of the plasma is not used in this invention thus a power savings. Many of the losses associated with fusion are eliminated by the direct configuration.

With two containments spinning, one can be used as a primary source and the second one as a backup. By using the primary until it is depleted and then switching over to the backup allows continued operation.

The containment of the fusion plasma is a capsule, wedge or other suitable design made with Pyrex®, ceramic or other suitable material with three electrodes, voltage electrode, ground electrode and power out electrode or four electrodes, voltage electrode, ground electrode, power out electrode, and RF in electrode. The RF in electrode is used for higher power.

The voltage electrode with a structure positioned proximate at the end of said electrode. The ground electrode with a structure positioned proximate at the end of said electrode. The power out electrode with a structure positioned proximate at the end of said electrode called a target. The RF in electrode with a structure positioned proximate at the end. The voltage electrode and ground electrode for being an insertion of power for accomplishing the fusion reaction. The structures can be open such as a screen or a closed structure. The screen would be used for the voltage electrode structure and closed structure for ground electrode and RF in electrode. The closed structures can be flat or curved.

The electrodes are insulated in the containment are insulated to prevent arcing outside the fusion reaction area.

The containment is in a low-pressure state and can withstand the heat generated by fusion reaction.

The fusion containment and holder is mechanically spun in a circle by a motor. There is a tradeoff between motor revolutions per minute and radius of the holder for the same centripetal force gravity.

As the motor revolutions per minute are increased, the gravity in the containment is also increased. The centripetal force gravity pull on the voltage electrode structure, ground electrode structure, and target which is connected to the power output electrode are different due to the positioning in the containment

The maximum gravity is on the target, placed behind the plasma, lesser gravity on the voltage electrode structure and least gravity on the ground electrode structure. If the RF in electrode structure is used it would be positioned at a lower gravity respect to the ground electrode structure. The acceleration by gravity, a ion starting at a lower gravity at the ground electrode structure to a higher gravity at the voltage electrode structure reduces its molecular motion due to increasing gravity and adds energy and acceleration to the ion. The target at the highest gravity level pulls the products from the fusion reaction from the voltage electrode structure in its direction. The fusion products collide with other nuclei on the way to the target and transfer their energy to these molecules and then to the target causing its energy level to increase.

The target made of graphite, beryllium or other suitable material. The target is mounted on a heat spreading dissipating conductor. The target and heat spreading dissipating conductor is supported above the containment with insulators. The conductor is facing the containment bottom. At the highest gravity level, the target receives the products from the fusion reaction from the voltage electrode structure.

The voltage electrode structure positioned proximate to the end of the electrode is held above the target with insulators.

The containment can take on various configurations to allow the gravity at the outside to be greater than the inside such as a rotating wedge or multiple rotating wedges or rotating capsule or multiple rotating capsules. The rotating wedges reduce the air turbulence created by the spinning fusion containments.

It is shown in U.S. Pat. No.5,160,695 the elements used for fusion is deuterium, deuterium and tritium, or hydrogen and boron-11. The gain for deuterium and tritium is 1000-2000. The gain for hydrogen and boron-11 is 50-100.

The fusion material can be deuterium, deuterium and tritium, hydrogen and boron-11 or other elements that can cause fusion. Tritium can be bread from a deuterium reaction with the use of lithium.

It is shown in U.S. Pat. No. 4,826,646 electrostatic acceleration will raise the temperature of the plasma.

The plasma is excited with differential high voltage energy, pulsing differential high voltage energy to accelerate the ions between the voltage electrode structure and ground electrode structure. A separate arc gap may be needed in series with the voltage electrode to increase the ionization voltage.

It is shown in U.S. Pat No. 4,837,772 how to make an ion cloud with RF.

With addition of the RF in electrode and structure in the containment placed at the lower gravity position respect to the ground electrode structure, the plasma is excited with a RF source to ionize the plasma in the vicinity of the ground electrode. The differential high voltage energy or pulsing differential high voltage energy between the voltage electrode structure and ground electrode structure is used to accelerate the ions and raise their temperature. A separate arc gap may be needed in series with the voltage electrode to increase the ionization voltage.

It is shown in U.S. Pat. No. 4,826,646 the target will accumulate the fusion reaction products and will operate at high positive electric potential and can drive electrical energy into any circuit to which the external structures are connected and which closes back to the plasma region.

The direct energy pickup from the target through the power out electrode would be at a MeV level requiring significant insulation to prevent arcing. A high voltage transformer converter can be connected to it.

The direct energy picked up by the target through the power out electrode can be used to arc a chamber. The arcing in the chamber limits the energy build up on the target. A capacitor stores the target energy unit the chamber arcs and dumps the energy in the arc. The arcing chamber produces a magnetic field for pick up with ferrite coil assemblies to create electricity.

The heat produced by the fusion reaction is captured by a heat chamber around the fusion containments and can be used to power turbines, heat engine, or other heat suitable device.

FIG. 1 shows the fusion containment. The containment is a Pyrex® glass 10, ceramic chamber or other suitable chamber with three electrodes and able to handle low pressure and heat generated by fusion. The voltage electrode 15 is the insertion of the power from the power supply for accomplishing the fusion reaction on voltage electrode structure 61. Insulators 12 support structure 61 to keep it from bending and shorting to the target 14. The Fill/Gnd electrode 16 with structure 62 is the ground reference for the power supply, ground reference for the power out electrode 17, and how the containment is filled. The power out electrode 17 connected to the target 14. The target 14 is placed behind the voltage electrode structure 61 and consists of graphite, beryllium or other suitable material that slows down the neutrons and captures the helium nuclei from the fusion reaction and collects their energy. The target 14 is mounted on a heat spreading dissipating conductor 18. The target 14 and heat spreading dissipating conductor 18 is supported above the containment by standoffs 12. The electrodes 15, 16, 17 are insulated by Pyrex® tubing 11 or other suitable material to insure no arcing occurs outside the reaction area.

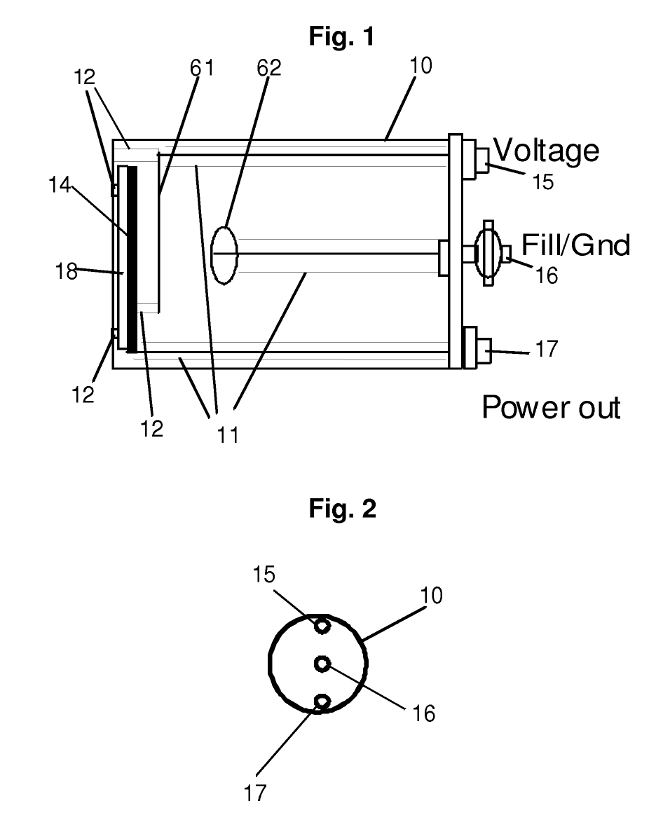

FIG. 2 shows the top view of the containment 10 of FIG. 1. The voltage electrode 15, Fill/Gnd electrode 16, power out electrode 17.

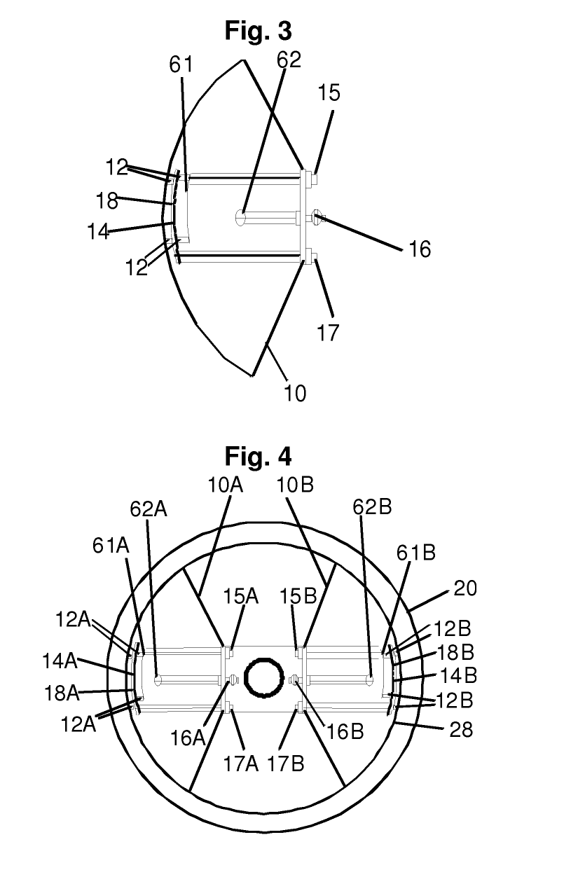

FIG. 3 shows the wedge fusion containment 10. The containment 19 is a Pyrex® glass, ceramic container or other suitable container with three electrodes and able to handle a low pressure and heat generated by fusion. The voltage electrode 15 is the insertion of the power from power supply for accomplishing the fusion reaction on voltage structure 61. Insulators 12 support voltage structure 61 to keep it from bending and shorting to the target 14. The Fill/Gnd electrode 16 with structure 62 is the ground return for the power supply, ground return for the power out electrode 17, and how the containment is filled. The power out electrode 17 connected to the target 14. The target 14 is placed behind the voltage electrode structure 61 and consists of graphite, beryllium or other suitable material that slows down the neutrons and captures the helium nuclei from the fusion reaction and collects their energy. The target 14 is mounted on a heat spreading dissipating conductor 18. The target 14 and heat spreading dissipating conductor 18 is supported above the containment by standoffs 12. The electrodes 15,16,17 are insulated by Pyrex® tubing 11 or other suitable material to insure no arcing, or occurs outside the reaction area.

FIG. 4 the top view of two wedge fusion containments 10 A, 10 B. mounted in fusion containment holder 28 of FIG. 3 The voltage electrodes 15A, 15B and structures 61 A, 61B, Fill/Gnd electrodes 16A, 16B, with structures 62A, 62B, power out electrodes 17A, 17B, with targets 14A, 14B, and case 20. The targets 14A, 14B is supported above the containment by standoffs 12A, 12B. The targets 14A, 14B are mounted on a heat spreading dissipating conductor 18A, 18B. The voltage electrode structures 61A, 61B is supported above the targets 14A, 14B with standoffs 12A, 12B.

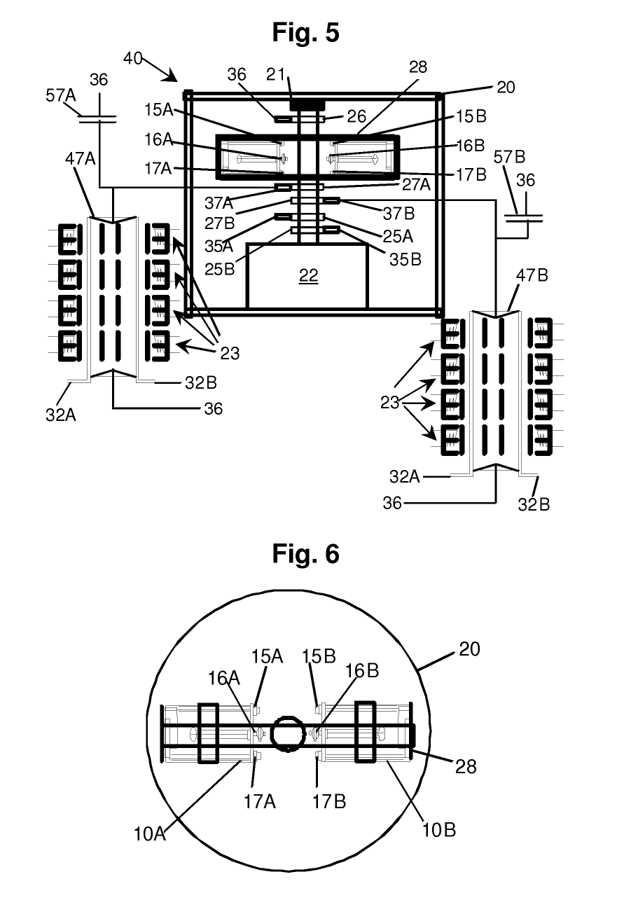

FIG. 5 the assembly 40 illustrates the two fusion containments in their holders 28 on the motor shaft for rotation with slip rings and brushes for connections to the voltage electrodes 15A, 15B, ground electrodes 16A, 16B, and power out electrodes 17A, 17B. The voltage electrodes 15A, 15B are connected to its respective slip ring 25A, 25B. The voltage output from the power supply is connected through brush 35A and a second power supply is connected through brush 35B. The ground electrode 16A, 16B are connected to slip ring 26 and through a brush 36 to the power supply ground, and is the ground return for the power out electrode,. The power out electrode 17A, 17B are connected to it respective slip ring 27A, 27B and are connected to an arc chamber 47A, 47B through brush 37A, 37B and the output from the arc chambers are connected to ground 36. Capacitors 57A, 57B are connected to brush 37A, 37B and accumulate the charge from voltage output electrodes 17A, 17B to arc the chambers 47A, 47B. The capacitors other end is connected to ground 36. The arc chambers 47A, 47B have ferrite coil assemblies 23 mounted around them. The ferrite coil assemblies 23 placed around the arc chambers to pick up the magnetic field. The arc chambers are cooled with fluid 32A input and 32B output. A motor 22 rotates the containment holder 28 and fusion containments and increases gravity in the fusion containments. The assembly is set in a case 20. Bearing 21 is used to support the motor shaft

FIG. 6 shows a top view of two mounted fusion containments 10A, 10B in their holder 28 of FIG. 5. The voltage electrode 15A, 15B, ground electrode 16A, 16B, and power out electrode 17A, 17B. The case is 20.

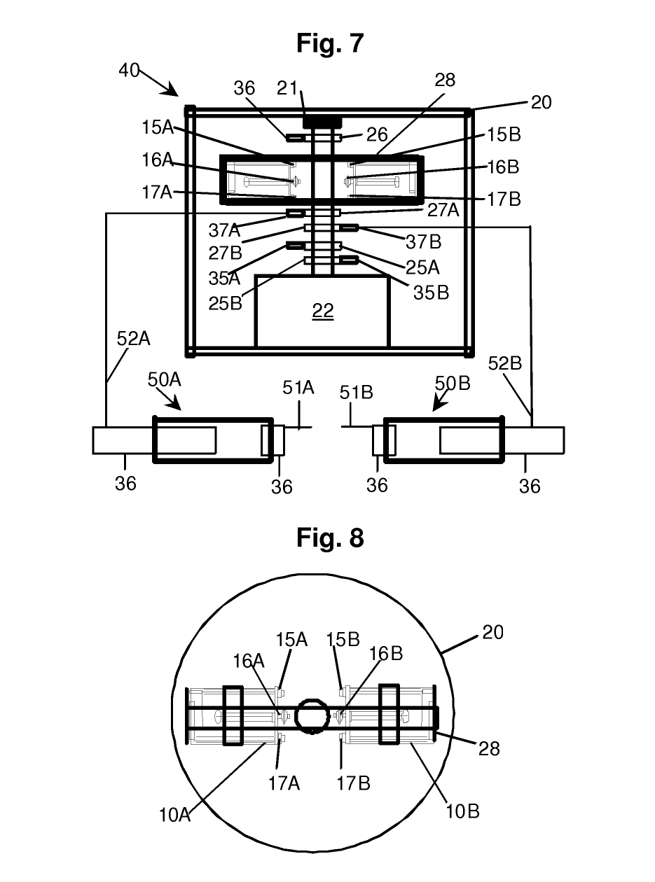

FIG. 7 the assembly 40 illustrates the two fusion containments in their holders 28 on the motor shaft for rotation with slip rings and brushes for connections to the voltage electrodes 15A, 15B, ground electrodes 16A, 16B. The voltage electrodes 15A, 15B are connected to its respective slip rings 25A, 25B. The voltage output from the power supply is connected through brush 35A to slip ring 25A and a second power supply is connected through brush 35B to slip ring 25B. The ground electrodes 16A, 16B are connected to slip ring 26 and through brush 36 to the power supply ground and is the ground return for the power out electrode 17A, 17B. The power out electrodes 17A, 17B are connected to it respective slip ring 27A, 27B and are connected to a transformers assemblies 50A, 50B through brush 37A, 37B to transformer coil inputs 52A, 52B and the output from the transformer coil assemblies 50A, 50B are connected to ground 36. The power outputs from transformer coil assemblies are 51A, 51B the other end of the coil is connected to ground 36. A motor 22 rotates the fusion containment holder 28 which and increases gravity in the fusion containments. The assembly is set in a case 20. Bearing 21 is used to support the motor shaft.

FIG. 8 shows a top view of two mounted fusion containment 10A, 10B in their holders 28 of FIG. 7. The voltage electrode 15A, 15B, ground electrode 16A, 16B. The power out electrodes are 17A, 17B. The assembly is set in a case 20.

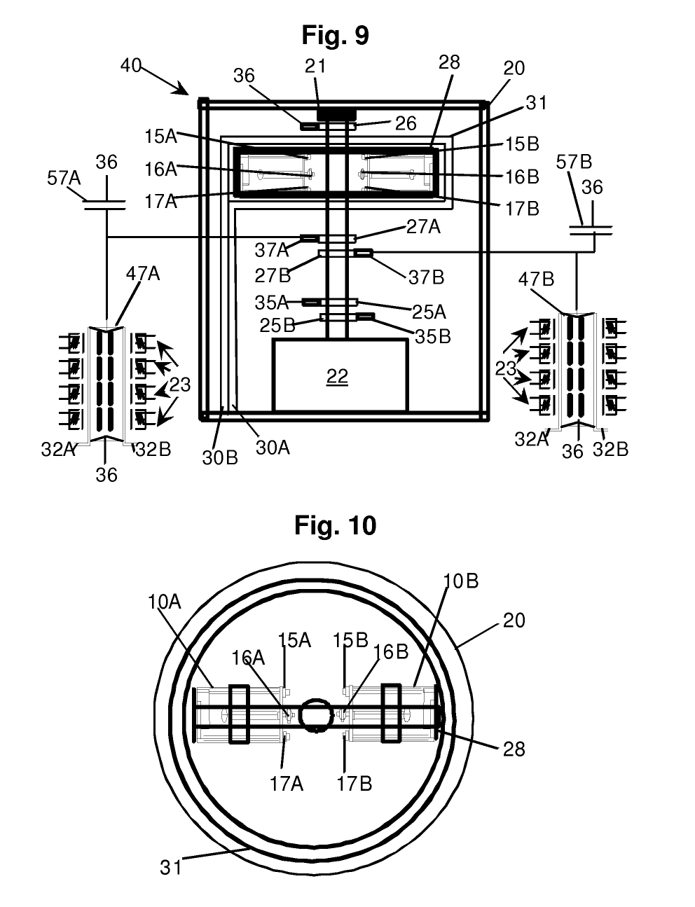

FIG. 9 the assembly 40 illustrates the two fusion containments in their holder 28 on the motor shaft for rotation with slip rings and brushes for connection to the voltage electrodes 15A, 15B and ground electrodes 16A, 16B. It also illustrates a heat chamber 31 around the fusion containments. The voltage electrodes 15A, 15B are connected to its respective slip ring 25A, 25B. The voltage output from the power supply is connected through brush 35A and a second power supply is connected through brush 35B. The ground electrodes 16A, 16B are connected to slip ring 26 and through a brush 36 to the power supply ground and is the ground return for the power out electrode 17A, 17B,. The power out electrodes 17A, 17B are connected to it respective slip ring 27A, 27B and are connected to an arc chambers 47A, 47B through brush 37A, 37B and the output from the arc chambers 47A, 47B are connected to ground 36. Capacitors 57A, 57B are connected to brush 37A, 37B and accumulate the charge from voltage output electrodes 17A, 17B to arc the chambers 47A, 47B. The other end of the capacitors 57A, 57B are connected to ground 36.The arc chambers 47A, 47B have ferrite coil assemblies 23 mounted around them. The ferrite coil assemblies 23 placed around the arc containment to pick up the magnetic field. The arc chambers are cooled with fluid 32A input and 32B output. A motor 22 rotates the fusion containments and increases gravity in the fusion containments. The heat chamber 31 surrounds the fusion containments to receive the heat produced by the fusion process. 30A is the inlet and 30B is the outlet to the heat chamber 31. The assembly is set in a case 20. Bearing 21 is used to support the motor shaft.

FIG. 10 shows a top view of two mounted fusion containments 10A, 10B in their holder 28 with the heat chamber 31 of FIG. 9. The voltage electrodes 15A, 15B, ground electrodes 16A, 16B power out electrodes 17A, 17B. The heat chamber 31 surrounds the fusion containments to receive the heat produced by the fusion process. The assembly is set in a case 20.

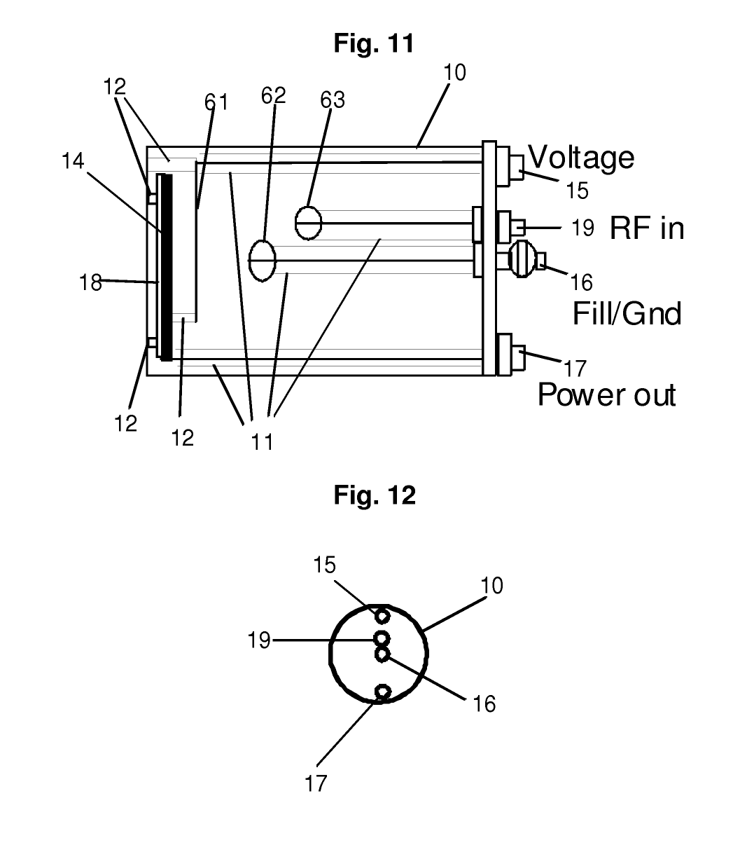

FIG. 11 shows the fusion containment. The containment is a Pyrex® glass 10, ceramic container or other suitable container with four electrodes and able to handle low pressure and heat generated by fusion. The voltage electrode 15 is the insertion of the power from the power supply for accomplishing the fusion reaction on voltage electrode structure 61. Insulators 12 support structure 61 to keep it from bending and shorting to the target 14. The Fill/Gnd electrode 16 with structure 62 is the ground return to the power supply, ground return for power out electrode, ground return for RF voltage generator, and how the containment is filled. The RF in 19 with structure 63 is connected to the RF voltage generator. The power out electrode 17 connected to the target 14. The target 14 is placed behind the voltage electrode structure 61 and consists of graphite, beryllium or other suitable material that slows down the neutrons and captures the helium nuclei from the fusion reaction and collects their energy. The target 14 is mounted on a heat spreading dissipating conductor 18. The target 14 and heat spreading dissipating conductor 18 is supported above the containment by standoffs 12. The electrodes 15, 16, 17, 19 are insulated by Pyrex® tubing 11 or other suitable material to insure no arcing occurs outside the reaction area.

FIG. 12 shows the top view of the fusion containment 10 of FIG. 11. The voltage electrode 15, Fill/Gnd electrode 16, RF in electrode 19, power out electrode 17.

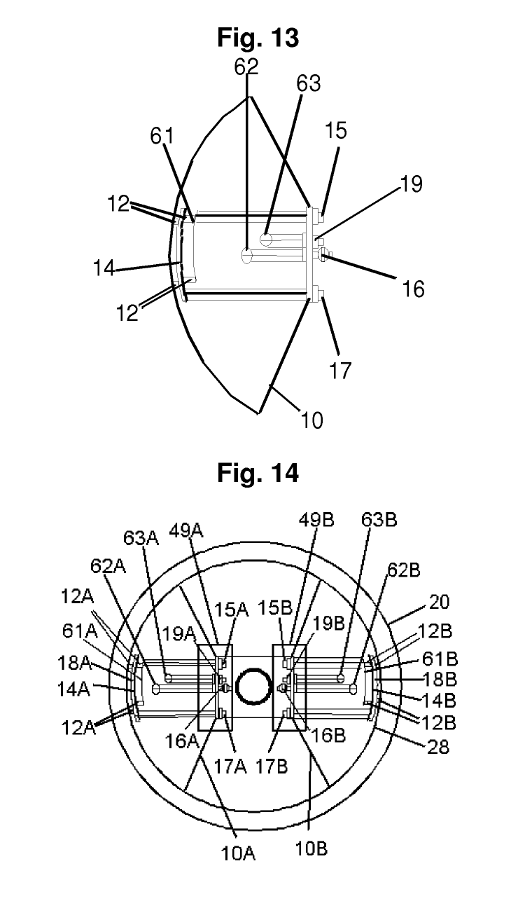

FIG. 13 shows the wedge fusion containment 10. The containment is a Pyrex® glass 10, ceramic container or other suitable container with four electrodes and able to handle low pressure and heat generated by fusion. The voltage electrode 15 is the insertion of the power from power supply for accomplishing the fusion reaction on voltage structure 61. Insulators 12 support voltage structure 61 to keep it from bending and shorting to the target 14. The Fill/Gnd electrode 16 with structure 62 is the ground return to the power supply, the ground return to the power out electrode 17, the ground return for RF voltage generator, and how the containment is filled. The RF in 19 with structure 63 is connected to the RF voltage generator. The power out electrode 17 connected to the target 14. The target 14 is placed behind the voltage electrode structure 61 and consists of graphite, beryllium or other suitable material that slows down the neutrons and captures the helium nuclei from the fusion reaction and collects their energy. The target 14 is mounted on a heat spreading dissipating conductor 18. The target 14 and heat spreading dissipating conductor 18 is supported above the containment by standoffs 12. The electrodes 15, 16, 17, 19 are insulated by Pyrex® tubing 11 or other suitable material to insure no arcing, or occurs outside the reaction area.

FIG. 14 the top view of two wedge fusion containments 10A, 10B. of FIG. 13 The voltage electrodes 15A, 15B and structures 61 A, 61 B, Fill/Gnd electrodes 16A, 16B, with structures 62A, 62B, power out electrodes 17A, 17B, with targets 14A,14B, RF in 19A with structure 63A is connected to the RF voltage generator 49A, RF in 19B with structure 63B is connected to RF voltage generator 49B, fusion containment holder 28, and case 20. The targets 14A, 14B is mounted on a heat spreading dissipating conductors 18A, 18B and above the containment by standoffs 12A, 12B. The voltage electrode structures 61 A, 61 B. are supported above the target 14A, 14B with standoffs 12A, 12B.

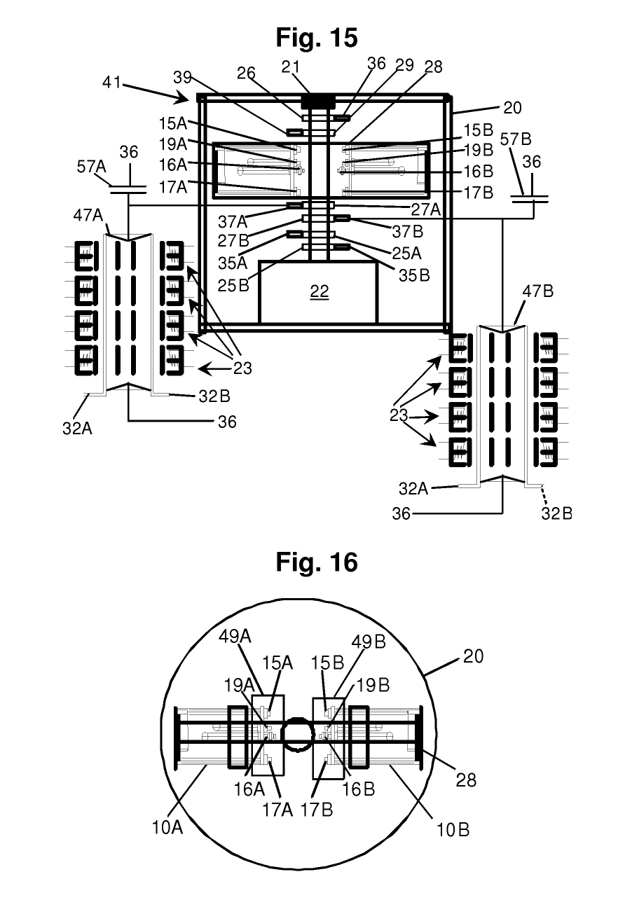

FIG. 15 the assembly 41 illustrates the two fusion containments in their holders 28 on the motor shaft for rotation with slip rings and brushes for connections to the voltage electrodes 15A, 15B, ground electrodes 16A, 16B, RF in electrodes 19A, 19B, and power out electrodes 17A, 17B. The voltage electrodes 15A, 15B with are connected to its respective slip ring 25A, 25B. The voltage output from the power supply is connected through brush 35A to slip ring 25A and a second power supply is connected through brush 35B to slip ring 25B. The power for the RF generators is through brush 39 to slip ring 29. The ground electrodes 16A, 16B are connected to slip ring 26 and through a brush 36 to the power supply ground, ground return for the power out electrode 17A, 17B and ground return for RF generator 49A, 49B. The power out electrodes 17A, 17B are connected to it respective slip rings 27A, 27B are connected to an arc chambers 47A, 47B through brush 37A, 37B and the output from the arc chambers 47A, 47B and are connected to ground 36. Capacitors 57A, 57B are connected to brush 37A, 37B and accumulate the charge from voltage output electrodes 17A, 17B to arc the chambers 47A, 47B. The other end of the capacitors 57A, 57B are connected to ground 36. The arc chambers 47A, 47B have ferrite coil assemblies 23 mounted around them. The ferrite coil assemblies 23 placed around the arc chamber pick up the magnetic field. The arc chambers are cooled with fluid 32A input and 32B output. A motor 22 rotates the fusion containments and increases gravity in the fusion containments. The assembly is set in a case 20. Bearing 21 is used to support the motor shaft.

FIG. 16 this figure shows the top view of two fusion containments 10A, 10B in their holder 28 of FIG. 15. The voltage electrodes 15A, 15B, Fill/Gnd electrodes 16A, 16B, RF in 19A is connected to the RF voltage generator 49A, RF in 19B is connected to RF voltage generator 49B, power out electrodes 17A, 17B, and case 20.

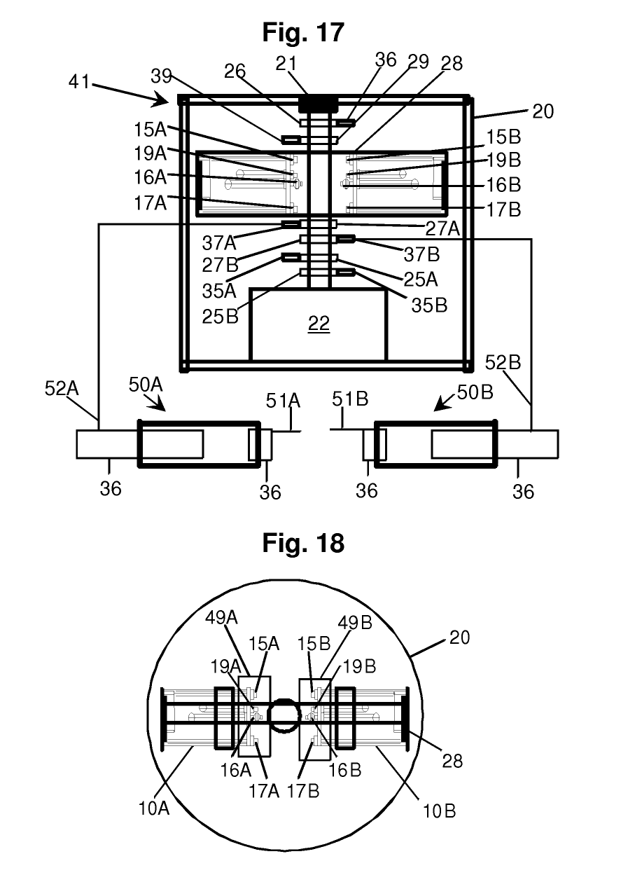

FIG. 17 the assembly 41 illustrates the two fusion containments in their holders 28 on the motor shaft for rotation with slip rings and brushes for connections to the voltage electrodes 15A, 15B, ground electrodes 16A, 16B, RF in electrodes 19A, 19B, and power out electrodes 17A, 17B. The voltage electrodes 15A, 15B are connected to its respective slip ring 25A, 25B. The voltage output from the power supply is connected through brush 35A and a second power supply is connected through brush 35B. The power for the RF generators is through brush 39 to slip ring 29. The ground electrodes 16A, 16B are connected to slip ring 26 and through a brush 36 to the power supply ground, ground return for the power out electrodes 17A, 17B, ground return for RF generators. The power out electrodes 17A, 17B are connected to it respective slip ring 27A, 27B and are connected to a transformers assemblies 50A, 50B through brush 37A, 37B to 52A, 52B and the output from the transformer assemblies 50A, 50B are connected to ground 36. The power outputs from transformer coil assemblies are 51A, 51 B the other end of the coil is connected to ground 36. A motor 22 rotates the fusion containments and increases gravity in the fusion containments. The assembly is set in a case 20. Bearing 21 is used to support the motor shaft.

FIG. 18 shows a top view of two mounted fusion containment 10A, 10B in their holders 28 of FIG. 17. RF in 19A is connected to the RF voltage generator 49A, RF in 19B is connected to RF voltage generator 49B. The voltage electrode 15A, 15B, ground electrode 16A, 16B. The power out electrodes are 17A, 17B. The assembly is set in a case 20.

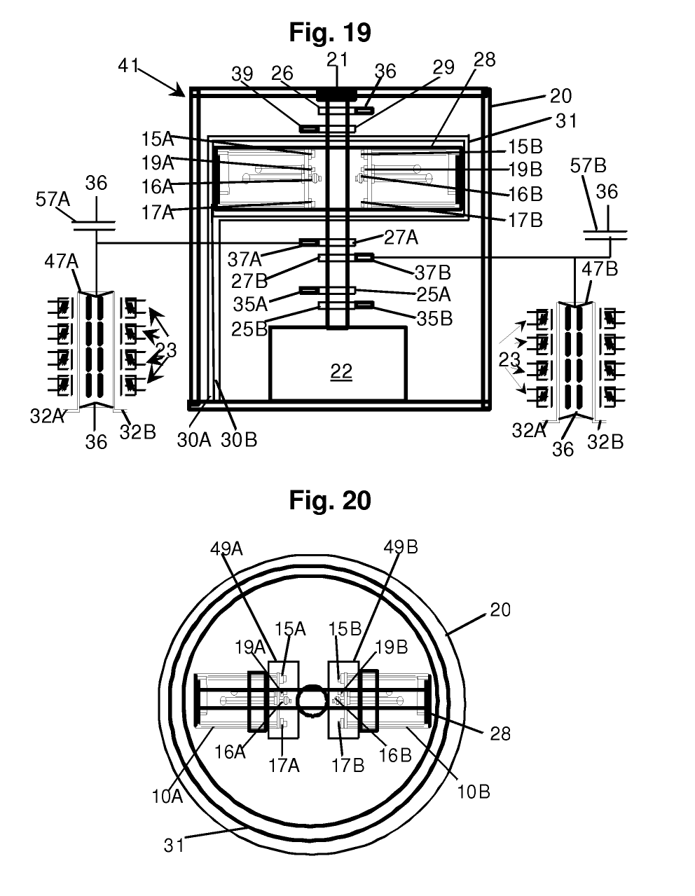

FIG. 19 The assembly 41 illustrates the two fusion containments in their holder 28 on the motor shaft for rotation with slip rings and brushes for connection to the voltage electrodes 15A, 15B, RF in electrodes 19A, 19B, ground electrodes 16A, 15B, and power out electrodes 17A, 17B. It also illustrates the heat chamber 31 around the fusion containments. The voltage electrodes 15A, 15B are connected to its respective slip ring 25A, 25B. The voltage output from the power supply is connected through brush 35A and a second power supply is connected through brush 35B. The power for the RF generators is through brush 39 to slip ring 29. The ground electrodes 16A, 16B are connected to slip ring 27A, 27B and through a brush 31 to the power supply ground, ground return for the power out electrodes 17A, 17B, ground return for RF generators. The power out electrodes 17A, 17B are connected to it respective slip ring 27A, 27B and are connected to an arc chambers 47A, 47B through brush 37A, 37B and the output from the arc chambers is connected to ground 36. The arc containments 47A, 47B have ferrite coil assemblies 23 mounted around them. Capacitors 57A, 57B are connected to brush 37A, 37B and accumulate the charge from voltage output electrodes 17A, 17B to arc the chambers 47A, 47B. The other end of the capacitors 57A, 57B are connected to ground 36. The ferrite coil assemblies 23 placed around the arc chambers to pick up the magnetic field. The arc chambers are cooled with fluid 32A input and 32B output. A motor 22 rotates the fusion containments and increases gravity in the fusion containments. The heat chamber 31 surrounds the fusion containments to receive the heat produced by the fusion process. 30A is the inlet and 30B is the outlet to the heat containment 31. The assembly is set in a case 20. Bearing 21 is used to support the motor shaft.

FIG. 20 shows a top view of the mounted fusion containment 10A, 10B in their holder 28 of FIG. 19. RF in 19A is connected to the RF voltage generator 49A, RF in 19B is connected to RF voltage generator 49B, the voltage electrodes 15A, 15B, ground electrodes 16A, 16B, power out electrodes 17A, 17B. The heat chamber 31 surrounds the fusion containments to receive the heat produced by the fusion process. The assembly is set in a case 20.

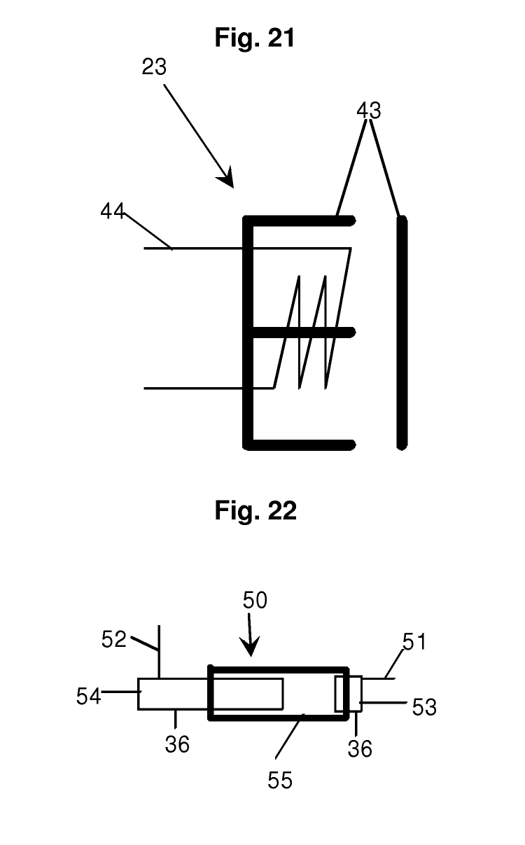

FIG. 21 shows assembly 23. The ferrite “E” core and ferrite closing bar 43 with a space between them. Dual “E” cores can be used with a space between the cores. The coil of wire 44 placed on the ferrite “E” core. The number of turns of the coil would be larger than what is shown.

FIG. 22 shows transformer ferrite core 55 assembly 50. The output from the fusion chamber is connected to 52 the input of the high turns ration coil 54, the output from the high turns ration coil is connected to ground 36. The output coil 53 is a low turns ratio coil and the power output is 51 and the other end of the coil is connected to ground 36. Both coils are mounted on a ferrite core 55. The high voltage coil is 54 and the low voltage coil is 53 has a turns ratio around 200,000:10.

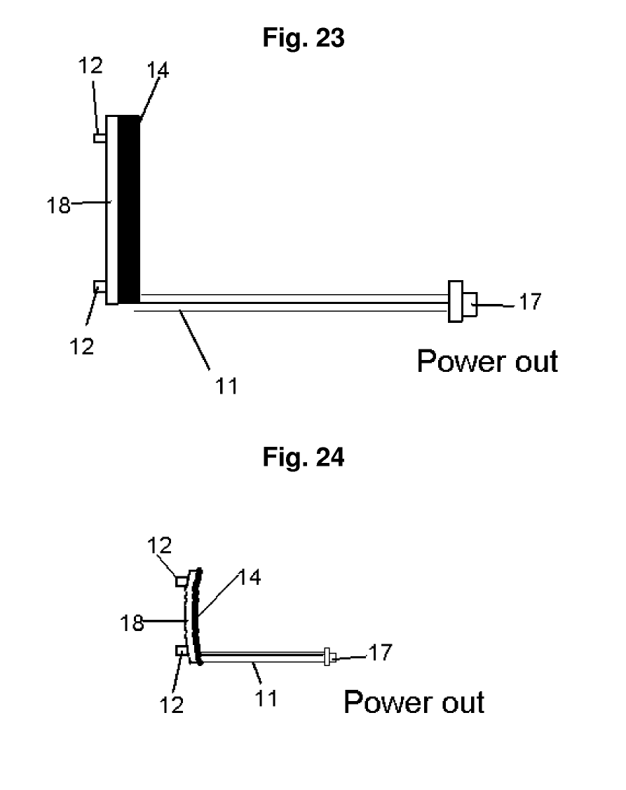

FIG. 23 shows the power output electrode 17 with target 14, for the containment shape, target 14 is mounted on a heat spreading dissipating conductor 18 and standoffs 12. The power out electrodes 17 is insulated by Pyrex® tubing 11 or other suitable material to insure no arcing occurs outside the reaction area.

FIG. 24 shows the power output electrode 17 with target 14 for the wedge shape, target 14 is mounted on a heat spreading dissipating conductor 18 and standoffs 12. The power out electrodes 17 is insulated by Pyrex® tubing 11 or other suitable material to insure no arcing occurs outside the reaction area.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

In conclusion, it is worth noting that the invention can be used for multiple purposes. Some uses are, the invention could be used to heat a house or business and provide electricity. The invention could be used in a car for power and heat when mounted in a gimble mount. It offers many new possibilities for unique applications

1. A nuclear fusion energy fusion energy apparatus, comprising:
a plurality of electrodes including a voltage electrode, a ground electrode, a power output electrode, optional RF in electrode;
a containment device, said plurality of electrodes being operatively coupled to said containment device, said containment device for holding a plasma made up of ions; and
a spinning apparatus, said containment device being coupled to said spinning apparatus, said spinning apparatus being configured to spin the containment device at a sufficient speed to create a force on the ions at a gravity level sufficient for dense fusion to occur.

2. The nuclear fusion energy apparatus of claim 1, further comprising a structure positioned proximate to an end of said voltage electrode and to an end of said ground electrode, said voltage electrode and said ground electrode for being for an insertion of power for accomplishing a fusion reaction.

3. The nuclear fusion energy apparatus of claim 1, wherein said electrodes in the containment are insulated to prevent arcing outside of the fusion reaction area.

4. The nuclear fusion energy apparatus of claim 1, wherein said fusion containment made from a suitable material that is able to handle the heat generated by fusion reaction at a low pressure.

5. The nuclear fusion energy apparatus of claim 1, wherein said motor mechanically rotates the fusion containments in a holder in a circle creating centripetal force gravity.

6. The nuclear fusion energy apparatus of claim 1, wherein said target is connected to said power output electrode which is placed in the containment behind the plasma for extraction of energy at the maximum gravity force position, said target be at least one a graphite and a beryllium, said target receives the products from the fusion reaction from the voltage electrode structure in its direction due to gravity force.

7. The nuclear fusion energy apparatus of claim 1, wherein said voltage electrode structure is placed from the target in a lower gravity position, said ground electrode structure is placed from the said voltage electrode structure in a lower gravity position, said gravity difference from the said ground electrode structure to the said voltage electrode structure is great enough to allow for the electron/ion acceleration gravity assist needed for fusion.

8. The nuclear fusion energy apparatus of claim 1, wherein said target is mounted on said heat spreading dissipating conductor, said heat spreading dissipating conductor is supported away the containment with insulators, said heat spreading dissipating conductor is facing the containment at the highest gravity level.

9. The nuclear fusion energy apparatus of claim 1, wherein said voltage electrode structure is supported above said target with insulators.

10. The nuclear fusion energy apparatus of claim 1, wherein said plasma containment can take on various configurations to allow gravity at the outside perimeter to be greater than the inside perimeter at least one a rotating wedge and a multiple rotating wedges and a rotating capsule and a multiple rotating capsules.

11. The nuclear fusion energy apparatus of claim 1, wherein source for the plasma is at least one of a deuterium ion source, a deuterium ion source and tritium ion source, a hydrogen ion source and a boron-11 ion source, a elements which can cause fusion.

12. The nuclear fusion energy apparatus of claim 1, further comprising: at least one of a differential high voltage energy and a pulsing differential high voltage energy to ionize the plasma, to accelerate the ions and raise their temperature.

13. The nuclear fusion energy apparatus of claim 1, wherein said separate arc gap may be used in series with the voltage electrode from the power supply to increase the ionization voltage.

14. The nuclear fusion energy apparatus of claim 1, further comprising: an optional radio frequency (RF) source, said RF source being configured to excite at least some of the ions in said containment device through the RF in electrode structure to ground electrode structure.

15. Apparatus of claim 14, said RF in electrode with a structure positioned proximate to an end of said electrode, said RF in electrode is placed at the lower gravity position respect to the ground electrode structure.

16. Apparatus of claim 6, wherein said power output electrode can be connected to a transformer.

17. Apparatus of claim 6, wherein said power output electrode is connected to an arc chamber, said arc chamber is used to limit the voltage on the said power output electrode.

18. Apparatus of claim 17, wherein said arc chamber is connected to a capacitor to store energy from said power output electrode, said arc chamber arcs at a voltage to discharge the capacitor through the said arc chamber.

19. Apparatus of claim 17, wherein said arc chamber has ferrite coil assemblies around the chamber to pickup the magnetic field from the arcing chamber for conversion to electricity.

20. The nuclear fusion energy apparatus of claim 1, wherein said heat containment surrounding the fusion containments captures the heat from the fusion containments.
